(19) United States
(12) Patent Application Publication
(10) Pub. No.: US 2012/0227670 A1
(43) Pub. Date: Sep. 13, 2012

(54) Automatic Fish Food Dispenser

(75) Inventors: Andrew S. Hudson, Oak Creek, WI (US); Thomas Robert Lutz, Franklin, WI (US)

(73) Assignee: CENTRAL GARDEN AND PET COMPANY, Walnut Creek, CA (US)

(21) Appl. No.: 13/416,067

(22) Filed: Mar. 9, 2012

Related U.S. Application Data
(60) Provisional application No. 61/450,968, filed on Mar. 9, 2011.

(51) Int. Cl. A01K 61/02

(52) U.S. Cl. 119/51.04

(57) ABSTRACT

Disclosed are fish food dispensers for aquariums, which are automatic and may be utilized to feed fish in the absence of the aquarist. The dispensers typically utilize a replaceable fish food container.

### BACKGROUND

The field of the invention relates to fish food dispensers for aquariums. In particular, the field of the invention relates to automatic fish food dispensers for aquariums.

Fish kept in an aquarium require feeding on a regular basis. Fish foods for aquarium fish typically consist of flakes, pellets, granules, or wafers, which must be added to the tank manually or may be automatically dispensed via an automatic dispenser should the aquarist not be available to feed the fish. An automatic dispenser typically includes either a hopper or a series of trays that must be hand filled by the aquarist with the desired food. This is time consuming and often results in spillage of food during transfer of the food from a retail package to a automatic dispenser.

Fish food dispensers are known in the art. (See, e.g., U.S. Pat. Nos. 7,500,447; 7,174,849; 6,009,835; 5,873,326; 5,199,381; 5,133,292; 5,003,925; 4,526,134; 4,296,710; and 4,256,058, the contents of which are incorporated herein by reference in their entireties). However, improved fish food dispensers exhibiting ease of use and modularity are desirable.

### SUMMARY

Disclosed are fish food dispensers for aquariums. The disclosed dispensers are automatic and may be utilized to feed fish in the absence of the aquarist.

In some embodiments of the disclosed dispensers, the dispensers include a motor for rotating a drive gear either directly or via a geared wheel. The drive gear may contact a periphery of a fish food container which is locked in the dispenser via a locking ring locking around a neck of the fish food container. The fish food container includes a lid having a scoop and an opening. As the motor causes the drive gear to rotate 360°, the drive gear, in turn, causes the fish food container to rotate 360°. As the fish food container rotates, the scoop in the lid of the container collects food from inside the container and permits the food to move from the inside of the container into the aquarium tank. Preferably, the dispenser includes a timer and/or controller for the motor, which may control power to the motor and/or modulate speed of the motor. The dispenser may be powered by any suitable power source, including, but not limited to a battery pack, a DC current, and/or a 110 or 220V AC current.

Preferably, the fish food container is positioned in the dispenser in a manner which permits food to pass from inside the container to the aquarium tank as the container rotates. For example, the fish food container may be angled with an open top end downward when locked in the locking ring.

The locking ring holds the fish food container in place within the dispenser while permitting the container to rotate. In some embodiments, the locking ring comprises rollers and/or bearings that contact the periphery of the fish food container and permit the container to rotate while locked in the locking ring. In some embodiments, the locking ring may be locked and/or opened via a lock-hinge mechanism permitting the fish food container to be inserted and/or removed.

The dispenser may be mounted on an aquarium tank by any suitable means. For example, the dispenser may be mounted via one or more mounting screws or one or more mounting clips for mounting the dispenser on a rim of a side wall of the aquarium tank.

### BRIEF DESCRIPTION OF THE DRAWINGS

FIG. 1 illustrates a side view of one embodiment of an automatic fish food dispenser as contemplated herein.

FIG. 2. illustrates a cross-sectional view of one embodiment of a housing for an automatic fish food dispenser as contemplated herein.

FIG. 3 illustrates a top view of one embodiment of a lid for a fish food container configured for use in an automatic fish food dispenser as contemplated herein.

### DETAILED DESCRIPTION

The subject matter disclosed herein is described using several definitions, as set forth below and throughout the application.

Unless otherwise specified or indicated by context, the terms “a,” “an,” and “the,” mean “one or more.” For example, “a dispenser” should be interpreted to mean “one or more dispensers,” and “a container” should be interpreted to mean “one or more containers.”

As used herein, the terms “include” and “including” have the same meaning as the terms “comprise” and “comprising.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≦10% of the particular term and “substantially” and “significantly” will mean plus or minus >10% of the particular term.

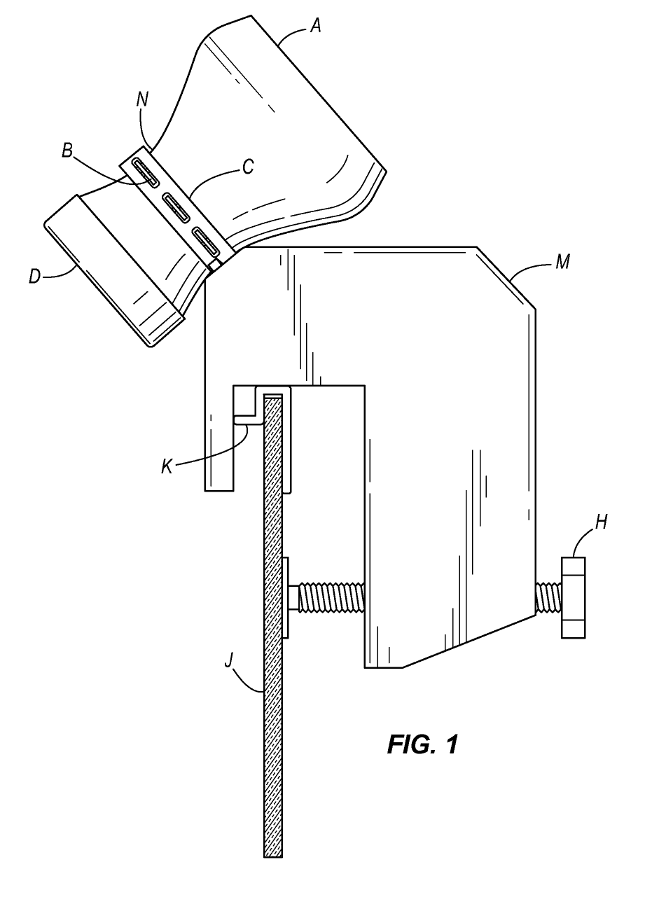

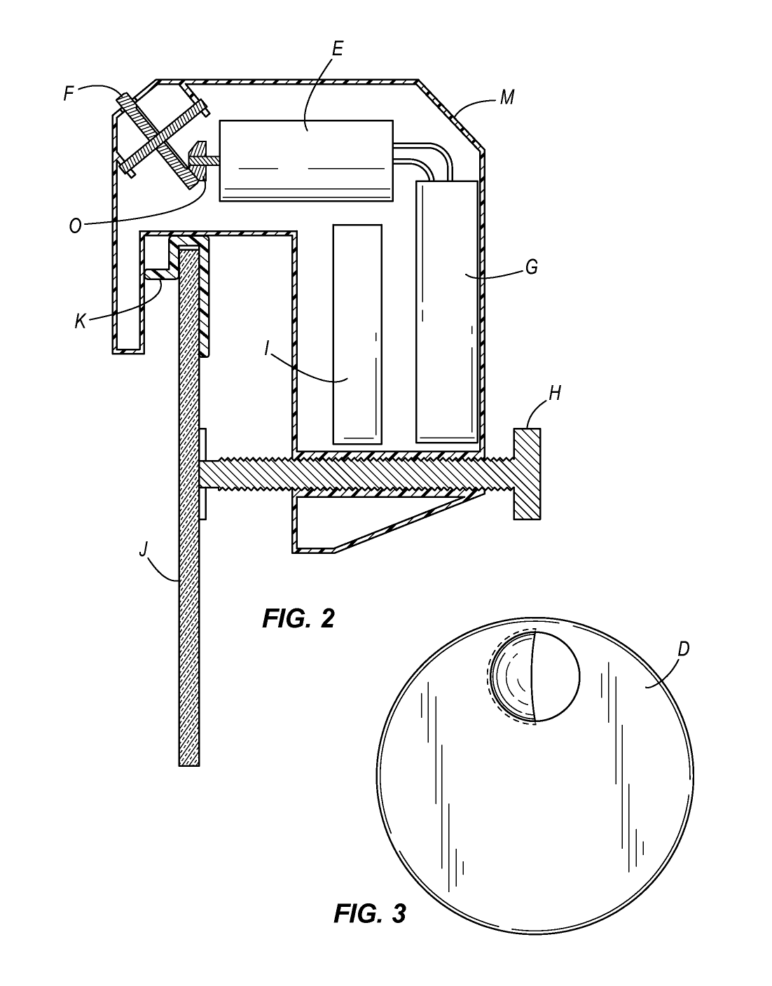

Referring now to FIGS. 1 and 2, shown are embodiments of an automatic fish food dispenser as contemplated herein. The dispenser is mounted on a top rim of a side wall J of an aquarium tank via one or more mounting screws H and a mounting clip or bracket K. The dispenser includes a housing M, that houses a motor E, a timer/controller G, and a battery case I that powers the motor M and the timer/controller G. Alternatively, the motor M and the timer/controller G may be powered by a low voltage DC current supplied from a main external current supply, or a 110 or 220V AC powered household current supply.

The motor E engages drive gear F either directly or indirectly via a geared wheel O that which turns at a predetermined time as set by the timer/controller G. The drive gear F engages a periphery of a fish food container A. As the drive gear F is rotated by the motor E, the drive gear causes the fish food container A to rotate so that the fish food container A makes one 360° rotation at a predetermined time period.

The fish food container is held in place by a locking ring C which is positioned about a neck N of the fish food container. The locking ring C is removable about the neck N of the fish food container, preferably via a lock/hinge mechanism. The locking ring C optionally includes roller rings or bearings B for engaging the neck of the fish food container A and facilitating rotation of the fish food container A when the fish food container is locked in the locking ring C and the drive gear rotates and contacts the periphery of the fish food container A. As such, the locking ring C holds the fish food dispenser A in place but reduces friction via the roller rings or bearings B so that the fish food dispenser A can spin freely within the locking ring C.

As shown in FIG. 3, in some embodiments, the fish food container A includes a lid D having a scoop and an opening permitting food to be moved from the fish food container A into the aquarium as the fish food container A rotates.

The fish food container A functions as a hopper in which fish food is stored. The fish food container A is removable and may be disposable and replaceable when empty with a new fish food container A that is full of fish food (i.e., a previously unopened retail container of fish food). This replacement method simplifies the process of loading automatic fish food dispensers in the prior art because the time required to load the dispenser is greatly reduced and there is no spillage of food. Prior to being inserted into the dispenser, the lid of the retail container of fish food is replaced with a feeding lid that includes the scoop and opening, for example, as shown in FIG. 3. During each rotation, the scoop in the lid dumps food from inside the container into the aquarium and scoops up food for the next feeding. When positioned in the dispenser, the fish food container A is angled downward so that all of the food within the container will flow with gravity down towards the lid. Alternatively, the dispenser may include a vibrating device which shakes the fish food container A to displace food.

It will be readily apparent to one skilled in the art that varying substitutions and modifications may be made to the invention disclosed herein without departing from the scope and spirit of the invention. The invention illustratively described herein suitably may be practiced in the absence of any element or elements, limitation or limitations which is not specifically disclosed herein. The terms and expressions which have been employed are used as terms of description and not of limitation, and there is no intention in the use of such terms and expressions of excluding any equivalents of the features shown and described or portions thereof, but it is recognized that various modifications are possible within the scope of the invention. Thus, it should be understood that although the present invention has been illustrated by specific embodiments and optional features, modification and/or variation of the concepts herein disclosed may be resorted to by those skilled in the art, and that such modifications and variations are considered to be within the scope of this invention.

Citations to a number of patent and non-patent references are made herein. The cited references are incorporated by reference herein in their entireties. In the event that there is an inconsistency between a definition of a term in the specification as compared to a definition of the term in a cited reference, the term should be interpreted based on the definition in the specification.

What is claimed is:

1. An automatic fish food dispenser for mounting on an aquarium tank, the dispenser comprising a motor for rotating a drive gear, the drive gear contacting a periphery of a fish food container, the fish food container locked in the dispenser via a locking ring locking around a neck of the fish food container, the fish food container comprising a lid having a scoop and an opening, wherein as the motor causes the drive gear to rotate, the drive gear causes the fish food container to rotate, and the scoop collects food from inside the fish food container and dumps the food into the aquarium tank.

2. The dispenser of claim 1, further comprising a timer or controller for the motor.

3. The dispenser of claim 1, further comprising a battery pack for powering the dispenser.

4. The dispenser of claim 1, wherein the dispenser is powered via a DC current.

5. The dispenser of claim 1, wherein the dispenser is powered via a 110 or 220V AC current.

6. The dispenser of claim 1, wherein the fish food container is angled downward when locked in the locking ring.

7. The dispenser of claim 1, wherein the locking ring comprises rollers or bearings that contact the periphery of the fish food container.

8. The dispenser of claim 1, further comprising one or more mounting screws for mounting the dispenser on a rim of a side wall of the aquarium tank.

9. The dispenser of claim 1, further comprising one or more mounting clips for mounting the dispenser on a rim of a side wall of the aquarium tank.

10. The dispenser of claim 1, wherein the motor engages the drive gear via a geared wheel.
